(19) United States
(12) Patent Application Publication
(10) Pub. No.: US 2025/0355946 A1
(43) Pub. Date: Nov. 20, 2025

(54) DYNAMIC PROMPT GENERATION FOR GENERATIVE ARTIFICIAL INTELLIGENCE BASED ON REACTIVE INTERACTIONS

(71) Applicant: Salesforce, Inc., San Francisco, CA (US)

(72) Inventors: Nathaniel Price, San Francisco, CA (US); Robert Van Osten, Chandler, AZ (US); Sean Lynch, San Francisco, CA (US); Joseph Chrzanowski, Lakewood, CO (US); Adam Evans, San Francisco, CA (US); Kristian Muñiz Feliciano, Lancaster, MA (US); Cameron Kennedy, San Francisco, CA (US)

(21) Appl. No.: 18/667,242

(22) Filed: May 17, 2024

(51) Int. Cl. G06F 16/9032

(52) U.S. Cl. CPC G06F 16/90332

(57) ABSTRACT

Methods, apparatuses, and computer-program products are disclosed. The method may include generating a first system message indicative of a role for the generative artificial intelligence (AI) model; generating a query-response message pair that includes a query message that may include an action invocation and a response message that includes information responsive to the action invocation; obtaining one or more interaction messages; generating a second system message that includes an instruction for the generative AI model to generate an utterance and an indication of one or more actions available to the generative AI model; transmitting, to the generative AI model, a prompt that may include the first system message, the query-response message pair, the one or more interaction messages, and the second system message; and receiving, from the generative AI model and based on the prompt, an output of the generative AI model.

### FIELD OF TECHNOLOGY

The present disclosure relates generally to database systems and data processing, and more specifically to dynamic prompt generation for generative artificial intelligence based on reactive interactions.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some cloud platform scenarios, the cloud platform, a server, or other device may utilize a generative artificial intelligence (AI) model to generate responses to user input. However, such methods may be improved.

### BRIEF DESCRIPTION OF THE DRAWINGS

FIG. 1 illustrates an example of a prompting a generative AI model system that supports dynamic prompt generation for generative artificial intelligence based on reactive interactions in accordance with examples as disclosed herein.

FIG. 2 shows an example of a processing system that supports dynamic prompt generation for generative artificial intelligence based on reactive interactions in accordance with examples as disclosed herein.

FIG. 3 shows an example of a process flow that supports dynamic prompt generation for generative artificial intelligence based on reactive interactions in accordance with examples as disclosed herein.

FIG. 4 shows an example of a process flow that supports dynamic prompt generation for generative artificial intelligence based on reactive interactions in accordance with examples as disclosed herein.

FIG. 5 shows a block diagram of an apparatus that supports dynamic prompt generation for generative artificial intelligence based on reactive interactions in accordance with examples as disclosed herein.

FIG. 6 shows a block diagram of a generative AI manager that supports dynamic prompt generation for generative artificial intelligence based on reactive interactions in accordance with examples as disclosed herein.

FIG. 7 shows a diagram of a system including a device that supports dynamic prompt generation for generative artificial intelligence based on reactive interactions in accordance with examples as disclosed herein.

FIG. 8 shows a flowchart illustrating methods that support dynamic prompt generation for generative artificial intelligence based on reactive interactions in accordance with examples as disclosed herein.

### DETAILED DESCRIPTION

In some cloud platform deployments, a generative artificial intelligence (AI) model may provide responses to user inputs. For example, a generative AI model may be employed in a “chatbot” setting in which a user has a conversation with the generative AI model to instruct the generative AI model to perform one or more tasks. However, existing approaches to using generative AI models may suffer from slow performance in such conversational setting due to the overhead of generating a full plan of action, and more difficult time recovering from invalid or unexpected input from a user and course correcting. This combination of factors leads to a user experience that would be unacceptable in a customer-facing scenario such as an autonomous customer support chatbot. Further, existing approaches to generative AI models often suffer from reduced performance, particularly when additional information is requested that is not available to the generative AI model.

An assistant will converse with a user in natural language and will prepare a prompt to transmit to the generative AI model. The prompt will include a chat history between the assistant and the user, as well as additional artificial messages to further ground and instruct the generative AI model. For example, such artificial messages may include an initial system message addressed to the generative AI model that describes the generative AI's “identity” and role, one or more query-response pairs that show examples of data query and retrieval (e.g., to teach the generative AI model that it should query the system to obtain additional information), and a second system message addressed to the generative AI model that indicates instructions and actions available to the generative AI model. The chat history and the artificially-inserted messages are bundled into a prompt that is provided to the generative AI model, which analyzes the information (both the chat history and the artificially inserted messages) to determine what the next output for the assistant to provide to the user should be. This structure allows for increased generative AI model accuracy and reduced prompt size, as the first and last messages are weighted more heavily than others when the generative AI model processes the prompt.

Aspects of the disclosure are initially described in the context of an environment supporting an on-demand database service. Aspects of the disclosure are then described with reference to a processing system, and process flows. Aspects of the disclosure are further illustrated by and described with reference to apparatus diagrams, system diagrams, and flowcharts that relate to dynamic prompt generation for generative artificial intelligence based on reactive interactions.

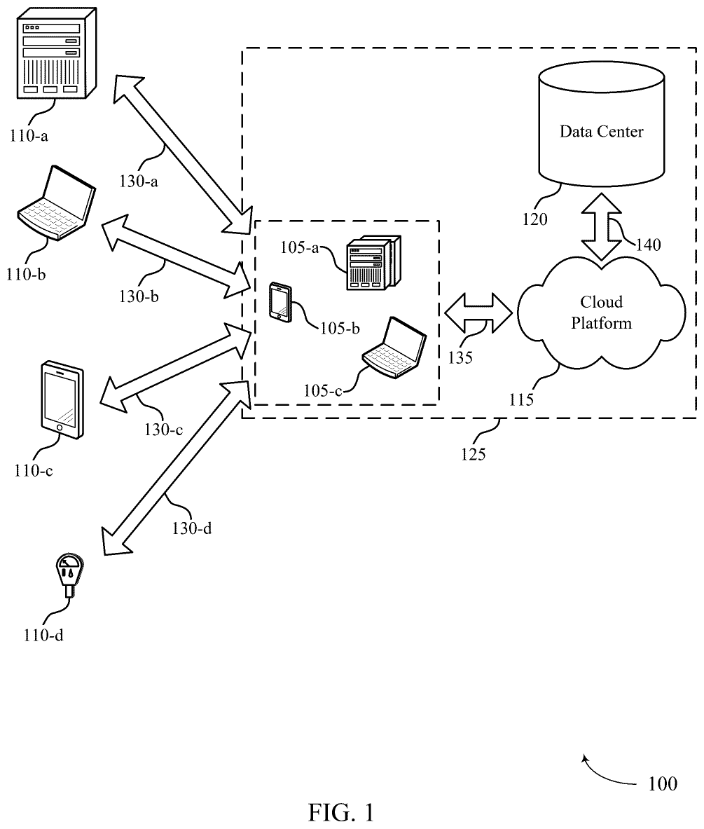

FIG. 1 illustrates an example of a system 100 for cloud computing that supports dynamic prompt generation for generative artificial intelligence based on reactive interactions in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

Additionally, or alternatively, the system 100 may support the use of a large language model (generative AI model), such as the generative AI component 145. In some examples, a generative AI component 145 may also be referred to as any of an artificial intelligence (AI), a generative AI (GAI), a GAI model, a large language model (LLM). The generative AI component 145 may be a model that is trained on a corpus of input data, which may include text, images, video, audio, structured data, or any combination thereof. Such data may represent general-purpose data, domain-specific data, or any combination thereof. Further, a generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may transmit a prompt to the generative AI component 145 that includes the query (or information included therein) and receive the generated output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located outside of the subsystem 125. However, the generative AI component 145 may be hosted on the cloud platform 115, elsewhere within the subsystem 125, or outside the subsystem 125 (e.g., a publicly-hosted platform). Additionally, or alternatively, multiple generative AI components 145 may be employed to perform one or more of the actions described as being performed by a single generative AI component 145. Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

For example, a cloud client 105 may communicate with the cloud platform 115 to obtain one or more responses to queries that are to be generated by the generative AI component 145. The cloud platform 115 may generate multiple messages that are to be included in a prompt to the generative AI component 145, such as system messages (e.g., that define roles and instructions), example interactions, functions, or actions, interaction histories (e.g., interactions with a cloud client 105), and other information that are provided to the generative AI component 145 in producing the desired output to be transmitted to the cloud client 105. This extra information provided to the generative AI component 145 may take advantage of weighting processes at the generative AI component 145 that more heavily weight some portions of prompts, as well as the pattern recognition abilities of the generative AI component 145 to generative improved responses to queries from the cloud client 105.

Existing approaches to generative AI models may suffer from slow performance in a conversational setting due to the overhead of generating a full plan of action, and more difficult time recovering from invalid or unexpected input from a user and course correcting. This combination of factors leads to a user experience that would be unacceptable in a customer-facing scenario such as an autonomous customer support chatbot. Further, some generative AI models may “indulge” a client and address content or prompts that fall outside of an originally-intended scope of a conversation or other interaction. Further, in some cases, prompting a generative AI model may involve large amounts of instructions, examples, or other information in a prompt, which may exceed an input capability or capacity (e.g., a quantity of tokens) of a generative AI model.

The techniques described herein involves an assistant service that stands between the client and the generative AI model. The assistant service may allow for modularization of inputs to the generative AI model and a prompt engineering framework that includes multiple system messages (e.g., that define roles and instructions), example interactions, functions, or actions, interaction histories, and other information that aids the generative AI model to produce more relevant and more accurate output. Such a framework takes advantage of the weighting of different elements in the prompt by the generative AI model, and strategically places information such that more important information is weighted more heavily by the generative AI model. Further, the assistant service may also employ the use of structured “topics” that provide further instructions to the generative AI model to aid the generative AI model in maintaining a context and relevant actions for the operation of the generative AI model, which reduces hallucinations and off-topic adventures engaged in by the generative AI model.

For example, a user may transmit a query to the assistant service, which may prepare a topic prompt and transmit the prompt to the generative AI model to determine a relevant topic or context for the interaction with the user. The assistant service may then prepare the focused prompt, which may include multiple system prompts, example interactions functions, or actions, interaction histories, topic information, or any combination thereof to determine whether additional actions are desirable to adequately respond to the user input as well as what those one or more actions may be. In some examples, the assistant service may perform such one or more actions, such as information retrieval, asking for additional information from the user, or other actions. The assistant service may also prepare an observation prompt that instructs the generative AI model to determine the next steps that are to be taken in the interaction with the user. The assistant service may then use the information from the performed action, if any, along with the results of the observation prompt, to provide the response to the user. This cycle of the focused prompt and response, together with the observation prompt and response, may be iterated throughout the duration of the interaction, to provide additional responses to additional queries by the user.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

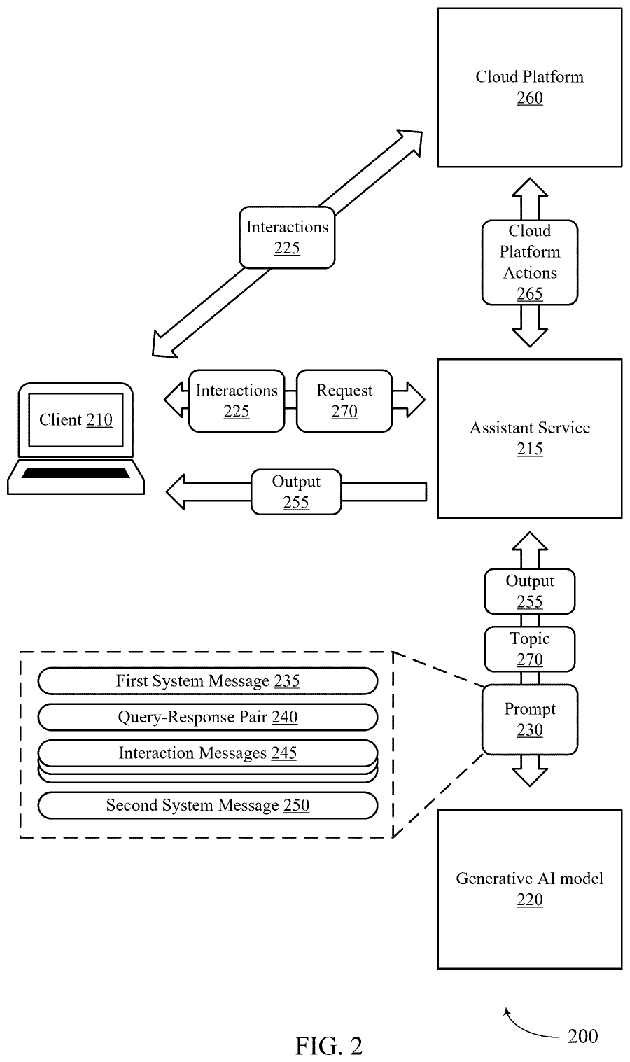

FIG. 2 shows an example of a processing system 200 that supports dynamic prompt generation for generative artificial intelligence based on reactive interactions in accordance with examples as disclosed herein. The processing system 200 may include a client 210, an assistant service 215, and a generative AI model 220. In some examples, the assistant service may be associated with a server, which may represent a single server or processing entity, multiple servers or processing entities, a complete processing system, or any other entity capable of performing the operations described herein. The generative AI model 220 may be included as part of or otherwise associated with the server or may operate independently of the server. Though some actions are described as being performed by some elements of the processing system 200, any element of the processing system 200 may perform any of the operations described herein and the discussion included herein considers non-exhaustive examples of the subject matter.

The processing system 200 may employ one or more prompting approaches to enhance user interaction by focusing on three key aspects: recognizing the client's 210 intent and context, performing an appropriate action in response, and prompting for further information or clarification. This approach ensures that the generative AI model 220 not only understands and responds accurately to user queries but also maintains a relevant and coherent conversation flow, including in complex or ambiguous situations. By doing so, it aims to improve the overall user experience, making interactions with AI more intuitive, responsive, and effective. For example, the generative AI model 220 may first recognize and understand the client's 302 query or statement, which may be included in the interactions. This involves interpreting the intent, context, and underlying meaning of the client's 302 input. After understanding the client's 302 input, the assistant service 215 takes action by formulating an appropriate response. This response is based on the content and context of the input and is tailored to provide relevant, accurate, and helpful information or feedback. If the client's 302 input is unclear or if additional information is desirable for a more accurate or comprehensive response, the assistant service 215 prompts the user for clarification or more details. This promotes a focused and productive conversation and comprehensive responses to the input from the client 210.

Such techniques may be more desirable than other approaches, including sequential approaches. For example, such techniques allow for dynamic, adaptive conversations that respond to the input from the client 210 in real-time, rather than following a predetermined, rigid sequence. This makes conversations feel more natural and engaging. Further, such techniques are more sensitive to the context of the conversation. For example, the assistant service 215 or the generative AI model 220 may not respond only to the immediate query but considers the overall dialogue flow, leading to more coherent and relevant interactions. Further, by prompting for clarification, the system 200 assists the generative AI model 220 to accurately understands the client's 302 intent, such as in cases of ambiguous or incomplete inputs. This leads to more precise and helpful responses. Further, such techniques are also suited for handling complex or multi-part queries, as the processing system 200 may manage and integrate various aspects of a conversation, whereas a sequential approach may struggle with such complexity, possibly involving reconfiguration, leading to performance issues.

The processing system 200 places the assistant service 215 in a conversation with the client 210 and the generative AI model 220. For example, the interactions between the client 210 and the assistant service 215 may include natural language interactions. Further, the assistant service 215 and the assistant service 215 communicate by executing actions and receiving an observation from the assistant service 215.

The assistant service 215 is reactive in the sense that it is put into a position to react to either client 210 input or system information (e.g., from the cloud platform 260, the generative AI model 220, or both.

The assistant service 215 utilizes a messages array that includes various elements from the interactions with the client 210, system messages, other information, or any combination thereof, allowing a natural weighting to the conversation messages. For example, multiple system prompts (e.g., the first system message 235, the query-response pair 240, and the second system message 250) are used throughout the conversation (and can be swapped or modified based on context changes). In some examples, the assistant service 215 may execute actions prior to sending a message back to the client 210 (e.g., e.g., including the cloud platform actions 265, such as data input, retrieval, or both). In some examples, the assistant service 215 may parse action indications from the generative AI model 220 to determine which actions, such as the cloud platform actions 265, to perform before returning a response to the generative AI model 220 or the client 210. Such techniques fit well with the intersection of how the generative AI model 220 interprets information, how a human user interacts with the assistant service 215, and how a prompt engineer would construct prompts.

For example, the assistant service 215 may generate the first system message 235 that may indicate a role that the generative AI model 220 is to perform or fulfil in association with responding to inputs. The assistant service 215 may further generate a query-response pair 240 that may include both an invocation of an action and a response message that includes information responsive to the action invocation. This invocation and response provides an example query to guide and “teach” the generative AI model 220 that it may generate a query and a response may be generated based on that query (e.g., by the assistant service 215, such as by performing one or more of the cloud platform actions 265 in association with the cloud platform 260). The assistant service 215 may further obtain one or more of the interactions performed by the client 210 with the assistant service 215, the cloud platform 260, or both, and may provide at least a portion of such interactions or information based on such interactions as the interaction messages 245. The interaction messages 245 may include or indicate past interactions, current interactions, or predicted interactions that may be relevant to one or more tasks being performed by the system 200. The assistant service 215 may further generate the second system message 250, which may include instructions to the generative AI model 220 to provide an utterance or other output 255 that is responsive to an input (e.g., the request) that may include one or more instructions, queries, or requests from the client 210. The assistant service 215 may assemble the prompt 230, which may include the first system message 235, the query-response pair 240, the interaction messages 245, and the second system message 250. The assistant service 215 may transmit the prompt 230 to the generative AI model 220, which may process the prompt 230 and produce the output 255 in response to the prompt 230. In some examples, the assistant service 215 may perform one or more actions (e.g., the cloud platform actions 265) in response to the output 255 and may modify or supplement the output 255 with additional information obtained in response to performing the one or more actions or may modify or supplement the output 255 in other ways, as described herein (e.g., such as reformatting the output 255 or converting the output 255 to natural language). Additionally, or alternatively, the assistant service 215 may pass the output 255 to the client 210 unmodified.

In some examples, the processing system 200 or one or more components thereof may employ the use of a chat completion application programming interface (API) that may apply additional weights to a chat history (e.g., one or more elements included in the prompt 230) that other approaches may not employ. For example, in association with the chat complete API, a first message (e.g., the first system message 235) may be given significant weight and the generative AI model 220 may more frequently understand or implement instructions in the content of this message. Similarly, a last message (e.g., the second system message 250) may be given significant weight and the generative AI model 220 may more frequently understand or implement instructions in the content of this message. In some examples, messages in between (e.g., the query-response pair 240, the interaction messages 245, one or more other messages or information, or any combination thereof) may be weighted by recency (e.g., in a non-linear fashion). Generally speaking, generative AI model 220 may understand or interpret recent messages more accurately or with greater weight than messages further back in the chat history.

The processing system 200 takes advantage of such weighting to both reduce prompt size and increase generative AI model 220 performance by placing some information in messages that are to be weighted more heavily. Each render cycle of the assistant service 215 provides an opportunity to manipulate the chat history as seen by that singular render cycle to place instructions at the more heavily weighted message locations.

In some examples, the first system message 235 may include structured information (e.g., a JavaScript Object Notation (JSON) object or other data object) that may describe the role of generative AI model 220, a tone to be used by the generative AI model 220, what tasks the generative AI model 220 is to perform, one or more topics or contexts to orient the generative AI model (e.g., as described herein), any global data that the generative AI model 220 may have access to (e.g., at the cloud platform 260) for the entirety of the conversation, or any combination thereof. The first system message 235 grounds the assistant service 215 and serves as a general system prompt to the generative AI model 220. For example, in a chat completion scenario in which the assistant service 215 is employed, the first system message 235 may be given significant weight. An example first system message 235 may be as follows:

{
“name”: “ACME”,
“author”: “You”,
“version”: “0.2”,
“company”: “ACME Technologies (acme.com) - ACME develops innovative
technology
“tone”: “clever, helpful, patient, empathetic, speak in short clear messages
“role”: “You are an AI customer service assistant for <company>. Help the customer
to resolve their problem
“presence”: “You are communicating with visitors on a website in a webchat”
}

In some examples, the query-response pair 240 may include one or more messages. For example, a first message (e.g., a query of the query-response pair 240) may include an action invocation to retrieve the current date or other information. By including such information, the assistant service 215 is teaching the generative AI model 220 that it should call actions in order to retrieve information. A second message (e.g., a response of the query-response pair 240) may include unstructured data or structured data (e.g., a JSON payload) that may include a date, time, or both that the conversation began. By including such information, the assistant service 215 is teaching the generative AI model 220 that it should expect a result from an action invocation and the format of that result.

In some examples, the prompt 230 may include the interaction messages 245. The interaction messages 245 may include one or more messages. For example, the interaction messages 245 may include a natural language greeting to the client that may be provided in response to the client 210 initiating a conversation or other interaction. Additionally, or alternatively, the interaction messages 245 may include one or more messages from a chat history between the assistant service 215, generative AI model 220, the client 210, the cloud platform 260, or any combination thereof. In some examples, such messages may be supplemented or modified (e.g., for formatting, easier interpretation by the generative AI model 220, or for one or more other reasons).

In some examples, the interaction messages 245 may include the request or information based on the request. In some examples, the request or information based on the request may be included separately from the interaction messages 245. The request is the message from the client 210 requesting the output 255 to be generated by the generative AI model 220.

In some examples, the prompt 230 may include the second system message 250. The second system message 250 may include unstructured data or structured data (e.g., a JSON object) that may include one or more instructions, one or more actions that may be invoked (e.g., the cloud platform actions 265), other information, or any combination thereof. The second system message 250 includes the instructions and available actions because the second system message 250 may be more heavily weighted than other messages. The second system message 250 may be given significant weight (e.g., due to being the last message in the chat completion or prompt 230). In some examples, the second system message 250 may be a temporary dynamic system message that describes the role or job of the generative AI model 220. For example, if you interactions with the processing system 200 are in one language and the processing system 200 is to transmit a message in another language, the next response will be very likely to be in the new language rather than the original based on the weighting of the second system message 250. Putting this information in the second system message 250 aids the generative AI model 220 to produce more reliable results. An example of a second system message 250 is included below:

{
“job”: “your job is to guide the client 210 through a Returns & Exchanges process”,
“rules”: [
“always use an action once a question is known”,
“do not use an action unless all the parameters have been captured from the
“the initial response must start with an action”,
“when you cannot help a customer always escalate”,
“never answer questions unless you've obtained direct information from product
“if the client 210 asks about anything outside of your job always escalate”
],
“actions”: {
“/escalate(“<description>“)”: “if the client 210 wants to discuss something unrelate
“/reply(“<text>“)”: “use this for any communication you want send back to the
}

This organization and inclusion of content of the prompt 230 allows the processing system 200 to establish a pattern of invoking actions to communicate with the generative AI model 220, receiving responses from the generative AI model 220, the cloud platform 260, the assistant service 215, or any combination thereof (e.g., in JSON format or as other structured data), and using natural language to communicate to the client 210 that is based on the responses to actions (e.g., those associated with the cloud platform 260).

As the generative AI model 220 is configured to follow patterns, the quantity of “mechanical” instructions included in the prompt 230 (e.g., those instructions showing the generative AI model 220 how to invoke actions) may be reduced and more tokens or capacity of the generative AI model 220 may be utilized for system message, prompt engineering, and information retrieval.

In some examples, an observation message or prompt may be transmitted to the generative AI model 220 (e.g., in response to the generative AI model 220 producing the output 255). Such an observation messages or prompt may instruct the generative AI model 220 to generate a response or determine the next steps to be taken in the overall interaction with the client 210. For example, when receiving the result of an update_record( ) action, it may be desirable to provide the action and its successful outcome (e.g., the successfully updated case) to the generative AI model 220 so it can produce an appropriate response. An example of an observation message or prompt is included below:

“status”: “SUCCESS”,
“response”: “Process has been initialized. The customer will receive an email to s
}

In some examples, if an action has failed for any reason (e.g., crash, bad input, bad output 255, or another reason) the assistant service 215 may transmit a prompt to the generative AI model 220 requesting that the generative AI model 220 determine what the next step should be, such as asking for different information, receive clarification from the client 210, or another action. Such a prompt may include the failed action, the corresponding failed result, and an instruction or request to determine an appropriate follow-up action. An example of such a prompt is shown below:

{
“status”: “FAILURE”,
“response”: “An error has occurred.”
}
The following is an example series of messages, transmissions, or information that
may occur in accordance with the techniques described herein.
[
{
“role”: “system”,
“content”: “{\”name\”: \”ACME\”, \”author\”: \”\”, \”version\”: \”0.2\”
},
{
“role”: “assistant”,
“content”: “/now( )”
},
{
“role”: “system”,
“content”: “{\”time\”: \”2023-12-09 11:51:10.841132\”}”
},
{
“role”: “client”,
“content”: “I'd like to update the Acme account”
},
{
“role”: “assistant”,
“content”: “/reply(\”Sure, I can help with that! Could you please provide me with the
updated information?
},
{
“role”: “client”,
“content”: “Change the phone number to 333-333-3333”
},
{
“role”: “system”,
“content”: “{\”job\”: \”your job is to handle questions related to look up que
},
{
“role”: “assistant”,
“content”: “/queryRecords(\”Acme account\”)”
{
“role”: “system”,
“content”: “{\”recordInfos\”: [{\”recordId\”: \”0017i00001So4EsAAJ\”, \”object
},
{
“role”: “assistant”,
“content”: “/updateRecord(\v0017i00001So4EsAAJ\v, {\vPhone\”: \”333-333-3333\”
},
{
“role”: “system”,
“content”: “{\”operationStatus\”: \”Success\”}”
},
“role”: “assistant service 215”,
“content”: “/reply(\”Great! The phone number for the Acme account has been
successfully updated }
]

In some examples, techniques involving topics may be used. As described herein, a topic may be a subject, scope, or context of interactions (e.g., the interactions) occurring between any of the client 210, the assistant service 215, the generative AI model 220, and the cloud platform 260. Additionally, or alternatively, a topic may be defined by a natural language categorization of jobs, scopes, contexts, or procedures that may guide operation of the processing system 200. In some examples, a topic includes or indicates metadata containing instructions for the generative AI model 220 for the corresponding topic, one or more actions involved with completion of those instructions, or both.

The use of topics may be helpful in various situations or scenarios, as it may be desirable that a service or implementation using a generative AI model 220 have the ability to recognize what scope it should be working within, as well as when the conversation has exited beyond the boundary of that scope. For example, if the request includes a question of “Why is the sky not purple”, the assistant service 215 should not indulge the client 210, but rather guide the client 210 to a topic that it was designed to handle. In another example, if the client 210 has an exceptional problem that the assistant service 215 cannot help with, the assistant service 215 may recognize that it cannot help the client 210 and the problem needs to be escalated (e.g., to another service or to a human).

As generative AI models may be designed produce the next most likely utterance that an assistant service 215 would say, other approaches may struggle to guide a generative AI model to a null hypothesis. For example, such a generative AI model may not consider whether it is an appropriate model for responding to user input. If such a model has insufficient instructions, it may hallucinate given its general training.

Thus, it may be desirable to construct the prompt (e.g., the prompt 230 or another prompt) in such a way that relevant instructions and actions will have reasonable probabilities of being selected given a scenario. In some examples, this may be done in such a way as to make the null hypothesis the most probable choice when no other action applies. Further, the techniques described herein also consider modularizing prompts for the generative AI model 220 to address the issue of limited input capacity when solving complex problems. For example, a quantity of instructions and actions to be provided to the generative AI model 220 may exceed an input capacity of the generative AI model 220, and modularization of inputs may reduce or resolve such issues.

In some examples, the processing system 200 may employ the use of topics, such as the topic 270, to provide guidance to the generative AI model 220, such as by delimiting use cases that the processing system 200 may match with a current scenario to accomplish a task requested by the client 210. Additionally, or alternatively, such topics 270 may be containers for other metadata, such as policies, actions, or instructions.

For example, the generative AI model 220 may determine the most relevant conversation topic based on the conversation history and a list of topics, with the output 255 being the most pertinent topic. In some examples, the generative AI model 220 may be provided with rules or procedures from the assistant service 215 indicating a scope of the interaction with the client 210 and one or more operations that may be performed if the interaction leaves the indicated scope.

For example, a prompt (e.g., the prompt 230 or another prompt) may be constructed. Such a prompt may include an indication of a classification of an upcoming utterance into one of a discrete set of topics. In some examples, the set of topics may cover various scopes of operation of the generative AI model 220, anticipating operations, scopes, and contexts in which the processing system 200 may operate. For example, a retail company might have topics such as product inquiries, order status updates, delivery issues, damage or defect claims, assembly and installation guidance, returns and exchanges, payment and billing queries, warranty and product care, and gift registry assistance. In some examples, even if a generative AI model 220 is not intended to handle interactions relating to a topic, it may still be provided with such a topic with instructions for the generative AI model 220 to indicate that it cannot help with that topic. Thus, the processing system 200 may be provided with a null hypothesis. In some examples, the processing system 200 may analyze one or more interactions and one or more topics to determine which actions the client 210 is requesting to be performed from multiple actions or capabilities.

In some examples, the provided instructions and actions associated with the topic 270 may orient the generative AI model 220 to produce an output 255 consistent with the topic 270 and the request. In some examples, if the request or other instructions from the client 210 are outside of the scope of the topic, the generative AI model 220 may determine that the request is outside of the topic and may reclassify the interaction as a whole. In some examples, if the request or other instructions from the client 210 are unrelated to any designated topic, the generative AI model 220 may guide the client 210 to a designated topic.

In addition to domain specific topics, there are several foundational or “plumbing” topics that govern the operation of the generative AI model 220 in scenarios in which none of the domain-specific topics apply (or in other situations that satisfy conditions for one or more such foundational or “plumbing” topics). For example, such foundational or “plumbing” topics may include a knowledge/frequently asked questions (FAQ) topic that is designed for fielding questions that relate to the business or operation scenario in which the generative AI model 220 operates that the generative AI model 220 may be designed to respond to, but may not fall within other topics. Another such topic may be a default topic that may be selected or utilized in scenarios in which no other topic (or one or more designated topics) are selected. Such a default topic may be designed to guide the interaction with the client 210 to one or more of the defined topics. Another foundational or “plumbing” topic may be a security quarantine topic. In scenarios in which the client 210 may appear to be manipulating the system in one or more ways, the generative AI model 220 may be placed into a quarantine mode that no longer has access to any actions and is instructed to end the conversation or interaction. Further, another foundational or “plumbing” topic may be an escalation topic that is used for the generative AI model 220 to escalate a problem that does not fall within the scope of any defined topics (or at least outside one or more designated topics). Such parameters or conditions for any of these topics may be defined by an administrator to customize the responses and behavior for different scenarios.

In some examples, the processing system 200 may determine one or more topics to be used for operation based on an analysis of the conversation. For example, the assistant service 215 may prepare a prompt that includes the interactions (e.g., a chat history) and instructions asking the generative AI model 220 to classify the topic of the next utterance. Once the topic is determined, the instructions, actions, and other metadata for the topic may be passed to the generative AI model 220 (e.g., in the prompt 230, including the first system message 235, the query-response pair 240, the interaction messages 245, and the second system message 250) to produce the output 255. In such a prompt, an action may be indicated to the generative AI model 220 that is to be used in cases in which the generative AI model 220 determines that the current topic is an incorrect topic or not application to the current interaction. If the generative AI model 220 invokes such an action, this may trigger a reclassification of the topic and the assistant service 215 may transmit another prompt 230 to the generative AI model 220 to produce new output 255 in accordance with a new topic.

In some examples, to implement the use of topics 270, a prompt may be used to instruct the generative AI model to determine the topic. An example topic prompt is included below:

Carefully comprehend the chat history between the bot and the user to determine a
topic from the list of topics below that will guide the interaction with the user.
[TOPICS]
OFF_TOPIC: non-customer service related
CHIT_CHAT: small talk but potentially customer service related
REVERSE_ENG: attempting to learn about or reverse engineer internal workings of
the system
SUPPORT: asking a support question related to a product or service they likely are
interested in
SALES: asking a product or service question to learn more about it
ORDER_ISSUE: asking about a recent order
RETURNS_EXCHANGES: asking to return an item from an order
GENERAL_FAQ: asking general questions about the company and its policies
ESCALATE: escalates to a human, representative, or agent.
[END TOPICS]
PERFORMANCE EVALUATION:
Think step-by-step and provide the ‘thoughts'.
VERY IMPORTANT: Analyze the execution result in the context of HISTORY.
You should only respond in JSON format as described below.
{
“category”: “<TOPIC>”,
}
Begin:
[USER INPUT]
I want to return my product
[END USER INPUT]

In some examples, validation of one or more responses or outputs 255 produced by the generative AI model may be performed. For example, a prompt may be provided to the generative AI model to request an analysis of the reasoning for taking one or more actions, and incorporating information of the responses into future prompts. Such approaches may reduce the quantity of tokens, action calls, or both associated with the operation of the generative AI model, and hallucinations of the generative AI model may be reduced, particularly in situations in which instructions or rules to guide operation of the generative AI model are not present or are less clear.

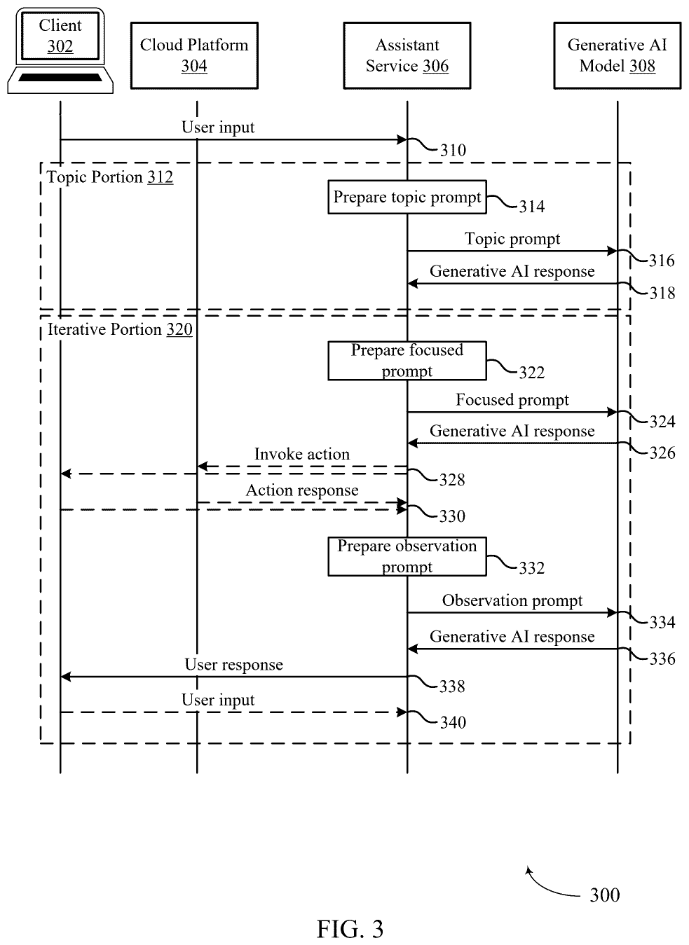

FIG. 3 shows an example of a process flow 300 that supports dynamic prompt generation for generative artificial intelligence based on reactive interactions in accordance with examples as disclosed herein. The process flow 300 may implement various aspects of the present disclosure described herein. The elements described in the process flow 300 (e.g., the client 302, the cloud platform 304, the assistant service 306, and the generative AI model 308) may be examples of similarly named elements described herein.

In the following description of the process flow 300, the operations between the various entities or elements may be performed in different orders or at different times. Some operations may also be left out of the process flow 300, or other operations may be added. Although the various entities or elements are shown performing the operations of the process flow 300, some aspects of some operations may also be performed by other entities or elements of the process flow 300 or by entities or elements that are not depicted in the process flow, or any combination thereof.

At 310, the assistant service 306 may receive the user input from the client 302.

At the topic portion 312, the assistant service 306 may perform one or more operations associated with topics as described herein. These operations may be called in response to a new session beginning to make the topics available for further steps. For example, the assistant service 306 may load and collect available topics from a topic service configuration.

At 314, the 306 may prepare and populate the topic prompt. The topic prompt may include instructions for the generative AI model 308 to classify the current interaction into a conversation topic, taking into account the conversation context and the most recent input from the client 302.

At 316 the assistant service 306 may transmit the topic prompt. At 318, the 308 may generate the response and transmit the response to the assistant service 306. The assistant service 306 may receive the output of the generative AI model 308 and may parse the topic from the generative AI model 308 result. The assistant service 306 may fetch the topic metadata associated with the identified topic, which may include conditions, actions, and instructions for how the agent should respond to the current interaction. Using the topic and the associated metadata, the assistant service 306 may produce a focus prompt (e.g., as part of the iterative portion 320) to be transmitted to the generative AI model 308 to generate the output responsive to the request from the client 302.

At the iterative portion 320, one or more operations may be performed iteratively throughout the course of interactions between the client 302, the cloud platform 304, the assistant service 306, and the generative AI model 308. For example, the iterative portion 320 may include a cycle of a user input stage, a focused prompt stage (optionally involving one or more actions to be performed), and an observation stage. Such stages may repeat iteratively to respond to new user input throughout the course of the interaction.

For example, at 322 the 306 may prepare the focused prompt to be transmitted to the generative AI model 308 (e.g., at 324). In some examples, the focused prompt may be an example of the prompt 230 described herein.

At 326, the assistant service 306 may receive the generative AI response and may parse one or more actions from the response, if applicable. If parsing the actions results in an error, the assistant service 306 may communicate an indication of the error to the client 302.

At 328, if one or more “core” or “custom” actions are present or indicated in the output, the assistant service 306 may engage in one or more actions, including actions involving the cloud platform 304, such as data retrieval or storage actions based on the indications in the generative AI response. Additionally, or alternatively, if a “reply” action is found, the assistant service 306 may transmit the generative AI response to the client 302. Additionally, or alternatively, if a “confirmation” action is found, the assistant service 306 may transmit a message or indication of the user that includes a confirmation dialog, requesting that the user confirm one or more actions before the one or more actions are carried out.

At 330, the assistant service 306 may receive an action response from the client 302, the cloud platform 304, or both. In some examples, the 306 may perform one or more additional actions in response, such as communicating the information to the 308 for further prompting and processing (e.g., in a subsequent loop of the iterative portion 320). Additionally, or alternatively, if any other specific prompts where information is desired or special prompts may be shown to the client 302, the assistant service 306 may treat such indications as an “action” that the generative AI model 308 will return and the assistant service 306 will interpret.

At 332, in response to successfully performing one or more actions, the assistant service 306 may generate an observation prompt to append to the chat history (e.g., the interactions). Additionally, or alternatively, In some examples, in response to unsuccessfully performing one or more actions, the assistant service 306 may generative a failed observation prompt to append to the chat history (e.g., the interactions).

At 334, the assistant service 306 may transmit the observation prompt to the 308, which may include an indication of successful execution (e.g., “Successfully updated Case 1234”) to the generative AI model 308 so it can produce an appropriate response to be transmitted to the client 302. Additionally, or alternatively, if an error is encountered in response to invoking an action, (e.g., an update_record ( ) action), the assistant service 306 may include both an indication of the action and an indication of the error message (e.g., “Failed to update the record”) in the observation prompt and transmit the observation prompt to the generative AI model 308 to produce a subsequent response.

At 336, the assistant service 306 may receive the generative AI response that may indicate a response to the transmitted to the client 302.

At 338, the assistant service 306 may transmit the user response to the client 302. The user response may include an output of the 308 that is responsive to the user input 310.

At 340, the client 302 may transmit further user input, which may trigger another cycle of the iterative portion 320 and trigger the 306 to prepare the focused prompt at 322.

In some examples, the content of a chat history or the interactions 225 may differ based on which operations are performed. For example, a chat history in a situation in which no follow-up is involved may be as follows:
Copilot: Welcome to the Copilot! Type ‘exit’ to quit.
You: Can you find all my open opportunities
Detecting topic . . .
Found the following topic: CRM_ACTIONS
Thinking . . .
Copilot:/queryRecords (“Find all open opportunities for the user”)
Running action ‘queryRecords’ . . .
={“recordInfos”: [{“recordId”: “0017i00001So4EsAAJ”, “objectType”: “Account”, “fieldV
Thinking . . .
Copilot: I found an open opportunity for you with the account named Acme. Here are
the
   Name: Acme
   Type: Prospect
   Phone: 3334448888
   Website: www.acme.com
   Industry: Technology
   Description: Acme is a Prospect in the Technology industry.
Please let me know if you need more information.

A chat history scenario involving user follow-up may be as follows:
Copilot: Welcome to the Copilot! Type ‘exit’ to quit.
You: Please update my opportunity
Detecting topic . . .
Found the following topic: CRM_ACTIONS
Thinking . . .
Copilot: Of course, I'd be happy to help you update your opportunity! Could you
please give me an opportunity ID?
You: 12345
Detecting topic . . .
Found the following topic: CRM_ACTIONS
Thinking . . .
Copilot: Sure thing! Could you please tell me what specific details you'd like to
update
You: Can you change the status to Deal Won!
Detecting topic . . .
Found the following topic: CRM_ACTIONS
Thinking . . .
Copilot:/updateRecord (“12345”, {“status”: “Deal Won”})
Running action ‘updateRecord’ . . .
={“operationStatus”: “Success”}
Thinking . . .
Copilot: Great news! Your opportunity with ID 12345 has been successfully updated

A chat history in which disambiguation may be clarified by the user may be as follows:
Copilot: Welcome to the Copilot! Type ‘exit’ to quit.
You: Can you update the Acme account
Detecting topic . . .
Found the following topic: CRM_ACTIONS
Thinking . . .
Copilot: Sure, I can help with that. Could you please provide me with more details
about the updates to be made?
You: Can you change the phone number to 333-333-3333
Detecting topic . . .
Found the following topic: CRM_ACTIONS
Thinking . . .
Copilot:/queryRecords (“Acme”)
Running action ‘queryRecords’ . . .
={“recordInfos”: [{“recordId”: “0017i00001So4EsAAJ”, “objectType”: “Account”, “fieldV
Thinking . . .
Copilot: I found two Acme accounts. One is a prospect with the phone number 3334448888 and the other is a prospect with the phone number 7778889999. Which one would you like to update?
You: 3334448888
Detecting topic . . .
Found the following topic: CRM_ACTIONS
Thinking . . .
Copilot:/updateRecord (“0017i00001So4EsAAJ”, {“Phone”: “333-333-3333”})
Running action ‘updateRecord’ . . .
={“operationStatus”: “Success”}
Thinking . . .
Copilot: Great news! The phone number for the Acme prospect account has been successfully updated!

A chat history in which the user may confirm one or more actions may be as follows:
Copilot: Welcome to the Copilot! Type ‘exit’ to quit.
You: Can you update the Acme account
Detecting topic . . .
Found the following topic: CRM_ACTIONS
Thinking . . .
Copilot: Sure, I can help with that. Could you please provide me with more details
You: Change the phone number to 333-333-3333
Detecting topic . . .
Found the following topic: CRM_ACTIONS
Thinking . . .
Copilot:/queryRecords (“Acme”)
Running action ‘queryRecords’ . . .
={“recordInfos”: [{“recordId”: “0017i00001So4EsAAJ”, “objectType”: “Account”, “fieldV
Thinking . . .
Copilot: I found the Acme account. The current phone number is 3334448888.
Would you like me to update it to 333-333-3333?
You: Yes
Detecting topic . . .
Found the following topic: CRM_ACTIONS
Thinking . . .
Copilot:/updateRecord (“0017i00001So4EsAAJ”, {“Phone”: “333-333-3333”})
Running action ‘updateRecord’ . . .
={“operationStatus”: “Success”}
Thinking . . .
Copilot: Great! The phone number for the Acme account has been successfully
updated!

A chat history in which the user responds and triggers a potential topic change may be as follows:
Copilot: Welcome to the Copilot! Type ‘exit’ to quit.
You: I want to update the Acme account
Detecting topic . . .
Found the following topic: CRM_ACTIONS
Thinking . . .
Copilot: Sure, I can help with that! Could you please provide me with more details
You: Actually, what is the weather?
Detecting topic . . .
Found the following topic: CHIT_CHAT
Thinking . . .
Copilot: I'm sorry for any confusion, but as an AI for Acme Technologies, I'm not equipped to provide the weather
You: Can we go back to updating the account?
Detecting topic . . .
Found the following topic: CRM_ACTIONS
Thinking . . .
Copilot: Of course! To assist you better, could you please provide more specific details about the update?

An example chat history in which an error occurs may be as follows:
Copilot: Welcome to the Copilot! Type ‘exit’ to quit.
You: Can you update the Acme account
Detecting topic . . .
Found the following topic: CRM_ACTIONS
Thinking . . .
Copilot: Sure, I can help with that. Could you please provide me with more details?
You: Can you change the phone number to 333-333-3333
Detecting topic . . .
Found the following topic: CRM_ACTIONS
Thinking . . .
Copilot:/queryRecords (“Acme”)
Running action ‘queryRecords’ . . .
={“recordInfos”: [{“recordId”: “0017i00001So4EsAAJ”, “objectType”: “Account”, “fieldV
Thinking . . .
Copilot: I found the Acme account. The current phone number is 3334448888.
Would you like me to update it to 333-333-3333?
You: Yes
Detecting topic . . .
Found the following topic: CRM_ACTIONS
Thinking . . .
Copilot:/updateRecord (“0017i00001So4EsAAJ”, {“Phone”: “333-333-3333”})
Running action ‘updateRecord’ . . .
={“operationStatus”: “ERROR”}
Thinking . . .
Copilot: I'm sorry, but I'm unable to update the phone number at the moment. Would you like me to try again or would you prefer to contact our support team?

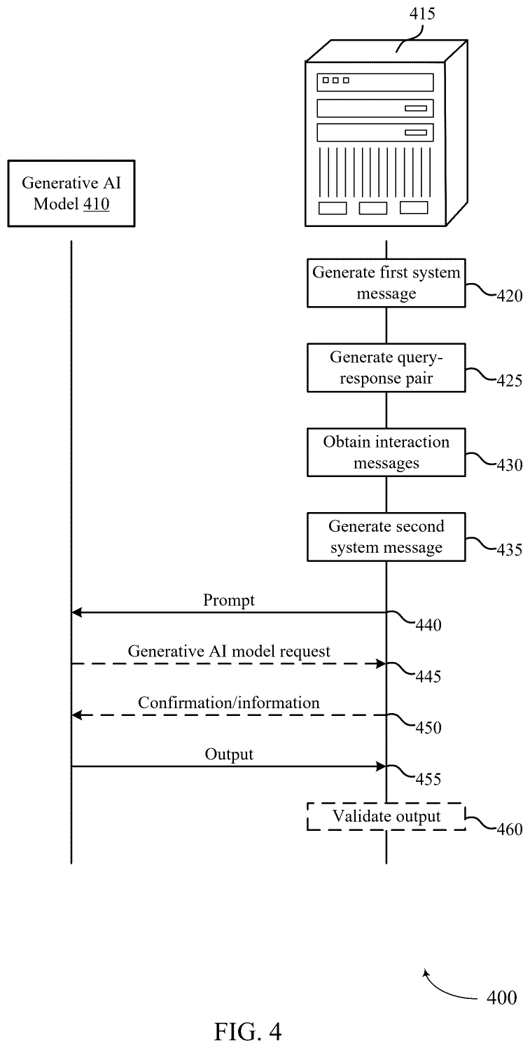

FIG. 4 shows an example of a process flow 400 that supports dynamic prompt generation for generative artificial intelligence based on reactive interactions in accordance with examples as disclosed herein. The process flow 400 may implement various aspects of the present disclosure described herein. The elements described in the process flow 400 (e.g., application server 415 and the generative AI model 410) may be examples of similarly named elements described herein.

In the following description of the process flow 400, the operations between the various entities or elements may be performed in different orders or at different times. Some operations may also be left out of the process flow 400, or other operations may be added. Although the various entities or elements are shown performing the operations of the process flow 400, some aspects of some operations may also be performed by other entities or elements of the process flow 400 or by entities or elements that are not depicted in the process flow, or any combination thereof.

At 420, the application server 415 may generate a first system message indicative of a role to be performed by the generative AI model 410. In some examples, the first system message is further indicative of a name associated with the generative AI model 410, an author associated with the generative AI model 410, a version associated with the generative AI model 410, a company associated with the generative AI model 410, a tone associated with the generative AI model 410, a presence associated with the generative AI model 410, or any combination thereof.

At 425, the application server 415 may generate a query-response message pair that may include a query message that may include an action invocation and a response message that may include information responsive to the action invocation. In some examples, the query-response message pair is selected based on a context in which the generative AI model 410 is to produce the output of the generative AI model 410.

At 430, the application server 415 may obtain one or more interaction messages associated with interactions between two or more of a user, an assistant service, and a processing system.

At 435, the application server 415 may generate a second system message that may include an instruction for the generative AI model 410 to generate an utterance to be provided to the user and an indication of one or more actions available to the generative AI model 410. In some examples, the one or more actions available to the generative AI model 410 comprise retrieval of information from the processing system. Additionally, or alternatively, the one or more actions available to the generative AI model 410 comprise prompting the user for additional information. Additionally, or alternatively, the one or more actions available to the generative AI model 410 comprise prompting the user for confirmation of an action selected from the one or more actions available to the generative AI model 410.

In some examples, the second system message may include an instruction for the generative AI model 410 to determine whether information is to be retrieved from the processing system. Additionally, or alternatively, the second system message may include an instruction for the generative AI model 410 to determine whether the additional information is to be requested from the user. Additionally, or alternatively, the second system message may include an instruction for the generative AI model 410 to determine whether selected actions are flagged for user confirmation.

In some examples, the second system message further may include an indication of one or more response domains selected from a set of response domains that may include a knowledge domain, a frequency asked questions domain, a security quarantine domain, an escalation domain, or any combination thereof. In some examples, the one or more response domains are selected based on an analysis of the first system message, the one or more interaction messages, the second system message, or any combination thereof.

At 440, the application server 415 may transmit, to the generative AI model 410, a prompt that may include the first system message, the query-response message pair, the one or more interaction messages, and the second system message.

At 445, the application server 415 may receive a request from the generative AI model 410 to retrieve information from the processing system. Additionally, or alternatively, the application server 415 may receive a request from the generative AI model 410 to request the additional information from the user. Additionally, or alternatively, the application server 415 may receive a request from the generative AI model 410 to request confirmation of the action from the user.

At 450, the application server 415 may transmit the retrieved information to the generative AI model 410 and the utterance to be provided to the generative AI model 410 is based on the retrieved information, and wherein the one or more interaction messages comprise the request from the generative AI model 410 to retrieve the information from the processing system and an indication of the transmission of the retrieved information to the generative AI model 410. Additionally, or alternatively, the application server 415 may transmit the additional information to the generative AI model 410 and the utterance to be provided to the generative AI model 410 is based on the additional information, and wherein the one or more interaction messages comprise the request from the generative AI model 410 to request the additional information from the user and an indication of the transmission of the additional information to the generative AI model 410. Additionally, or alternatively, the application server 415 may transmit the confirmation to the generative AI model 410 and the utterance to be provided to the generative AI model 410 is based on the confirmation, and wherein the one or more interaction messages comprise the request from the generative AI model 410 to request the confirmation from the user and an indication of the transmission of the confirmation to the generative AI model 410.

At 455, the application server 415 may receive, from the generative AI model 410 and based on the prompt, an output of the generative AI model 410 indicating the utterance to be provided to the user by the assistant service. In some examples, interactions between the user and the assistant service are expressed in plain language, interactions between the generative AI model 410 and the assistant service are expressed in a structured data format, and interactions between the assistant service and the processing system are expressed in the structured data format.

At 460, the application server 415 may validate the output of the generative AI model 410 to determine whether the utterance indicated in the output of the generative AI model 410 is responsive to the instruction for the generative AI model 410 to generate the utterance.

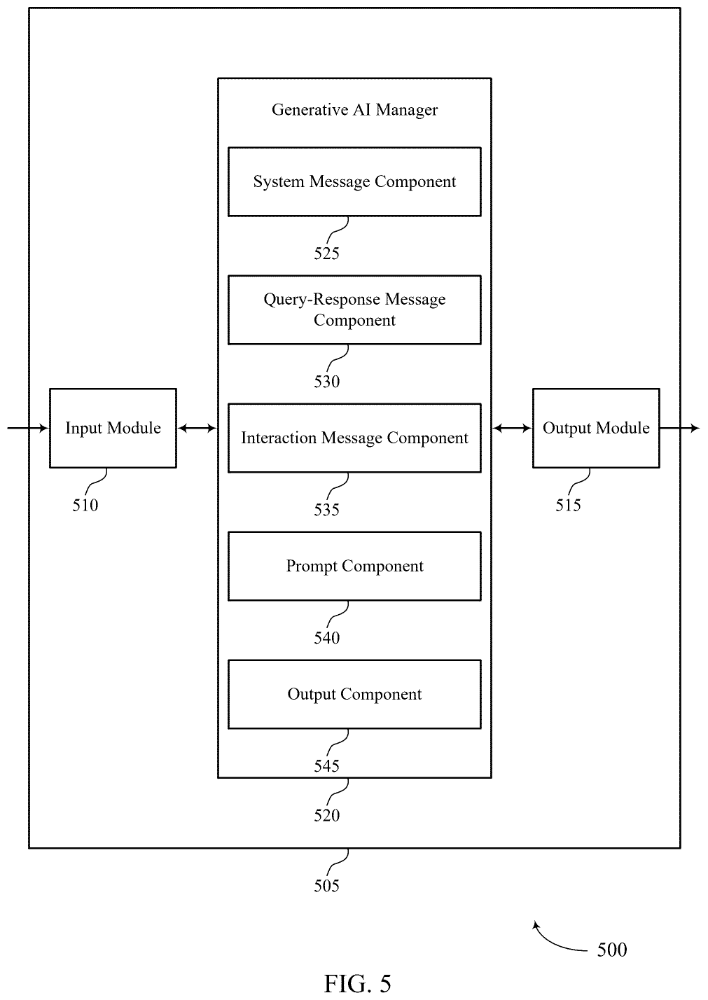

FIG. 5 shows a block diagram 500 of a device 505 that supports dynamic prompt generation for generative artificial intelligence based on reactive interactions in accordance with examples as disclosed herein. The device 505 may include an input module 510, an output module 515, and a generative AI manager 520. The device 505, or one or more components of the device 505 (e.g., the input module 510, the output module 515, the generative AI manager 520), may include at least one processor, which may be coupled with at least one memory, to support the described techniques. Each of these components may be in communication with one another (e.g., via one or more buses).

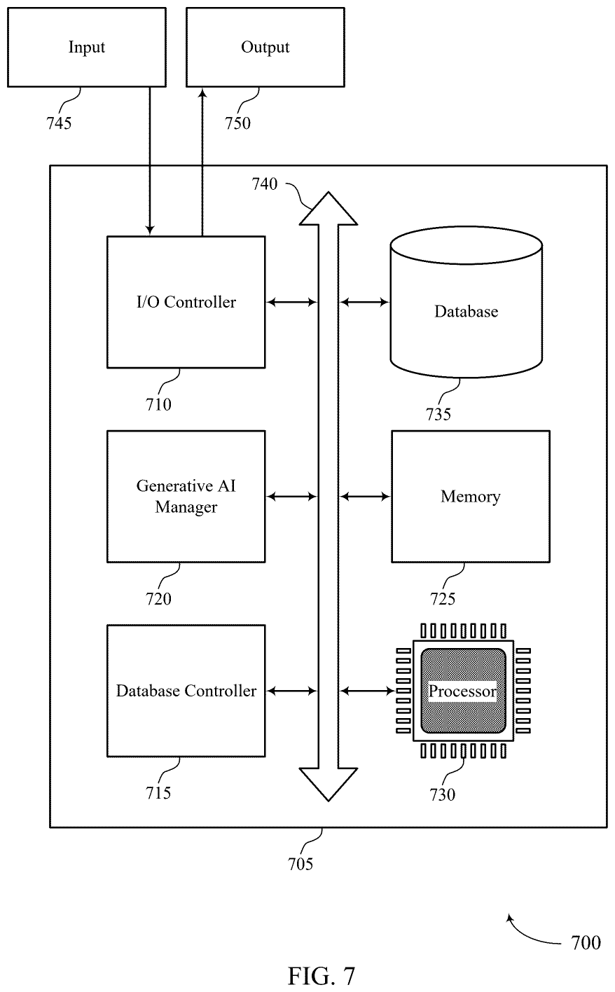

The input module 510 may manage input signals for the device 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the device 505 for processing. For example, the input module 510 may transmit input signals to the generative AI manager 520 to support dynamic prompt generation for generative artificial intelligence based on reactive interactions. In some cases, the input module 510 may be a component of an input/output (I/O) controller 710 as described with reference to FIG. 7.

The output module 515 may manage output signals for the device 505. For example, the output module 515 may receive signals from other components of the device 505, such as the generative AI manager 520, and may transmit these signals to other components or devices. In some examples, the output module 515 may transmit output signals for display in a user interface, for storage in a database or data store, for further processing at a server or server cluster, or for any other processes at any quantity of devices or systems. In some cases, the output module 515 may be a component of an I/O controller 710 as described with reference to FIG. 7.

For example, the generative AI manager 520 may include a system message component 525, a query-response message component 530, an interaction message component 535, a prompt component 540, an output component 545, or any combination thereof. In some examples, the generative AI manager 520, or various components thereof, may be configured to perform various operations (e.g., receiving, monitoring, transmitting) using or otherwise in cooperation with the input module 510, the output module 515, or both. For example, the generative AI manager 520 may receive information from the input module 510, send information to the output module 515, or be integrated in combination with the input module 510, the output module 515, or both to receive information, transmit information, or perform various other operations as described herein.

The system message component 525 may be configured to support generating a first system message indicative of a role to be performed by the generative AI model. The query-response message component 530 may be configured to support generating a query-response message pair including a query message including an action invocation and a response message including information responsive to the action invocation. The interaction message component 535 may be configured to support obtaining one or more interaction messages associated with interactions between two or more of a user, an assistant service, and a processing system. The system message component 525 may be configured to support generating a second system message including an instruction for the generative AI model to generate an utterance to be provided to the user and an indication of one or more actions available to the generative AI model. The prompt component 540 may be configured to support transmitting, to the generative AI model, a prompt including the first system message, the query-response message pair, the one or more interaction messages, and the second system message. The output component 545 may be configured to support receiving, from the generative AI model and based on the prompt, an output of the generative AI model indicating the utterance to be provided to the user by the assistant service.

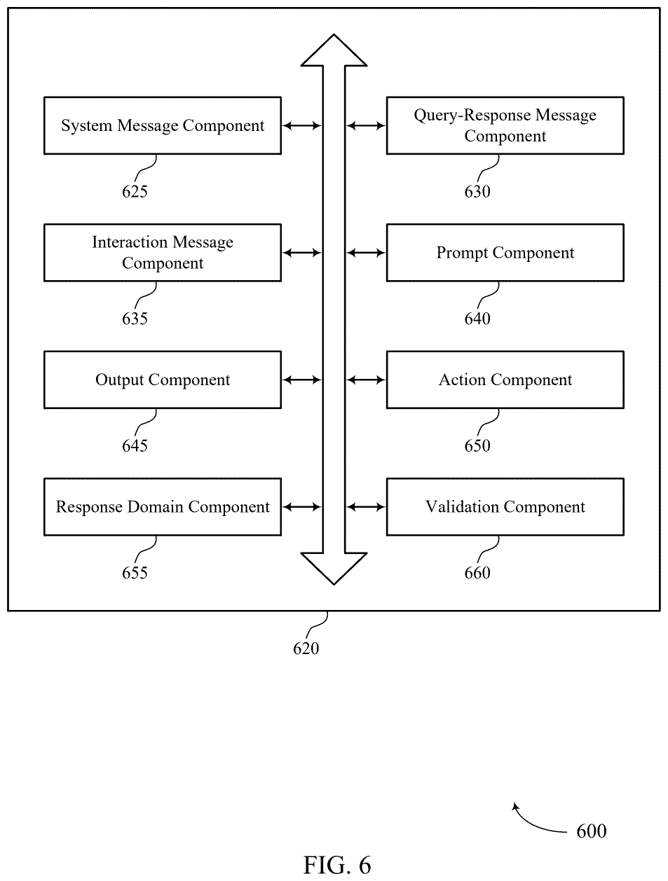

FIG. 6 shows a block diagram 600 of a generative AI manager 620 that supports dynamic prompt generation for generative artificial intelligence based on reactive interactions in accordance with examples as disclosed herein. The generative AI manager 620 may be an example of aspects of a generative AI manager or a generative AI manager 520, or both, as described herein. The generative AI manager 620, or various components thereof, may be an example of means for performing various aspects of dynamic prompt generation for generative artificial intelligence based on reactive interactions as described herein. For example, the generative AI manager 620 may include a system message component 625, a query-response message component 630, an interaction message component 635, a prompt component 640, an output component 645, an action component 650, a response domain component 655, a validation component 660, or any combination thereof. Each of these components, or components of subcomponents thereof (e.g., one or more processors, one or more memories), may communicate, directly or indirectly, with one another (e.g., via one or more buses).

The system message component 625 may be configured to support generating a first system message indicative of a role to be performed by the generative AI model. The query-response message component 630 may be configured to support generating a query-response message pair including a query message including an action invocation and a response message including information responsive to the action invocation. The interaction message component 635 may be configured to support obtaining one or more interaction messages associated with interactions between two or more of a user, an assistant service, and a processing system. In some examples, the system message component 625 may be configured to support generating a second system message including an instruction for the generative AI model to generate an utterance to be provided to the user and an indication of one or more actions available to the generative AI model. The prompt component 640 may be configured to support transmitting, to the generative AI model, a prompt including the first system message, the query-response message pair, the one or more interaction messages, and the second system message. The output component 645 may be configured to support receiving, from the generative AI model and based on the prompt, an output of the generative AI model indicating the utterance to be provided to the user by the assistant service.

In some examples, the one or more actions available to the generative AI model include retrieval of information from the processing system. In some examples, the second system message includes an instruction for the generative AI model to determine whether information is to be retrieved from the processing system. In some examples, the method further includes receiving a request from the generative AI model to retrieve information from the processing system, and transmitting the retrieved information to the generative AI model, where the utterance to be provided to the generative AI model is based on the retrieved information, and where the one or more interaction messages include the request from the generative AI model to retrieve the information from the processing system and an indication of the transmission of the retrieved information to the generative AI model.

In some examples, the one or more actions available to the generative AI model include prompting the user for additional information. In some examples, the second system message includes an instruction for the generative AI model to determine whether the additional information is to be requested from the user. In some examples, the method further includes receiving a request from the generative AI model to request the additional information from the user, and transmitting the additional information to the generative AI model, where the utterance to be provided to the generative AI model is based on the additional information, and where the one or more interaction messages include the request from the generative AI model to request the additional information from the user and an indication of the transmission of the additional information to the generative AI model.

In some examples, the one or more actions available to the generative AI model include prompting the user for confirmation of an action selected from the one or more actions available to the generative AI model. In some examples, the second system message includes an instruction for the generative AI model to determine whether selected actions are flagged for user confirmation. In some examples, the method further includes receiving a request from the generative AI model to request confirmation of the action from the user, and transmitting the confirmation to the generative AI model, where the utterance to be provided to the generative AI model is based on the confirmation, and where the one or more interaction messages include the request from the generative AI model to request the confirmation from the user and an indication of the transmission of the confirmation to the generative AI model.

In some examples, the second system message further includes an indication of one or more response domains selected from a set of response domains including a knowledge domain, a frequency asked questions domain, a security quarantine domain, an escalation domain, or any combination thereof. In some examples, the one or more response domains are selected based on an analysis of the first system message, the one or more interaction messages, the second system message, or any combination thereof.

In some examples, the first system message is further indicative of a name associated with the generative AI model, an author associated with the generative AI model, a version associated with the generative AI model, a company associated with the generative AI model, a tone associated with the generative AI model, a presence associated with the generative AI model, or any combination thereof.

In some examples, the query-response message pair is selected based on a context in which the generative AI model is to produce the output of the generative AI model.

In some examples, the validation component 660 may be configured to support validating the output of the generative AI model to determine whether the utterance indicated in the output of the generative AI model is responsive to the instruction for the generative AI model to generate the utterance.

In some examples, interactions between the user and the assistant service are expressed in plain language, interactions between the generative AI model and the assistant service are expressed in a structured data format, and interactions between the assistant service and the processing system are expressed in the structured data format.

FIG. 7 shows a diagram of a system 700 including a device 705 that supports dynamic prompt generation for generative artificial intelligence based on reactive interactions in accordance with examples as disclosed herein. The device 705 may be an example of or include components of a device 505 as described herein. The device 705 may include components for bi-directional data communications including components for transmitting and receiving communications, such as a generative AI manager 720, an I/O controller, such as an I/O controller 710, a database controller 715, at least one memory 725, at least one processor 730, and a database 735. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. In other cases, the I/O controller 710 may represent or interact with a modem, a keyboard, a mouse, a touchscreen, or a similar device. In some cases, the I/O controller 710 may be implemented as part of a processor 730. In some examples, a user may interact with the device 705 via the I/O controller 710 or via hardware components controlled by the I/O controller 710.

The database controller 715 may manage data storage and processing in a database 735. In some cases, a user may interact with the database controller 715. In other cases, the database controller 715 may operate automatically without user interaction. The database 735 may be an example of a single database, a distributed database, multiple distributed databases, a data store, a data lake, or an emergency backup database.

Memory 725 may include random-access memory (RAM) and read-only memory (ROM). The memory 725 may store computer-readable, computer-executable software including instructions that, when executed, cause at least one processor 730 to perform various functions described herein. In some cases, the memory 725 may contain, among other things, a basic I/O system (BIOS) which may control basic hardware or software operation such as the interaction with peripheral components or devices. The memory 725 may be an example of a single memory or multiple memories. For example, the device 705 may include one or more memories 725.

The processor 730 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in at least one memory 725 to perform various functions (e.g., functions or tasks supporting dynamic prompt generation for generative artificial intelligence based on reactive interactions). The processor 730 may be an example of a single processor or multiple processors. For example, the device 705 may include one or more processors 730.

For example, the generative AI manager 720 may be configured to support generating a first system message indicative of a role to be performed by the generative AI model. The generative AI manager 720 may be configured to support generating a query-response message pair including a query message including an action invocation and a response message including information responsive to the action invocation. The generative AI manager 720 may be configured to support obtaining one or more interaction messages associated with interactions between two or more of a user, an assistant service, and a processing system. The generative AI manager 720 may be configured to support generating a second system message including an instruction for the generative AI model to generate an utterance to be provided to the user and an indication of one or more actions available to the generative AI model. The generative AI manager 720 may be configured to support transmitting, to the generative AI model, a prompt including the first system message, the query-response message pair, the one or more interaction messages, and the second system message. The generative AI manager 720 may be configured to support receiving, from the generative AI model and based on the prompt, an output of the generative AI model indicating the utterance to be provided to the user by the assistant service.

By including or configuring the generative AI manager 720 in accordance with examples as described herein, the device 705 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

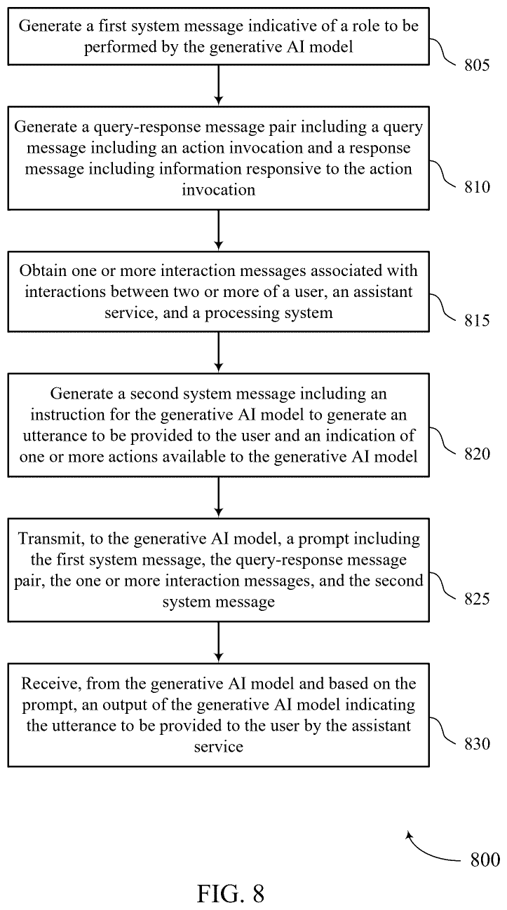

FIG. 8 shows a flowchart illustrating a method 800 that supports dynamic prompt generation for generative artificial intelligence based on reactive interactions in accordance with examples as disclosed herein. The operations of the method 800 may be implemented by an application server or its components as described herein. For example, the operations of the method 800 may be performed by an application server as described with reference to FIGS. 1 through 7. In some examples, an application server may execute a set of instructions to control the functional elements of the application server to perform the described functions. Additionally, or alternatively, the application server may perform aspects of the described functions using special-purpose hardware.

At 805, the method may include generating a first system message indicative of a role to be performed by the generative AI model. The operations of 805 may be performed in accordance with examples as disclosed herein. In some examples, aspects of the operations of 805 may be performed by a system message component 625 as described with reference to FIG. 6.

At 810, the method may include generating a query-response message pair including a query message including an action invocation and a response message including information responsive to the action invocation. The operations of 810 may be performed in accordance with examples as disclosed herein. In some examples, aspects of the operations of 810 may be performed by a query-response message component 630 as described with reference to FIG. 6.

At 815, the method may include obtaining one or more interaction messages associated with interactions between two or more of a user, an assistant service, and a processing system. The operations of 815 may be performed in accordance with examples as disclosed herein. In some examples, aspects of the operations of 815 may be performed by an interaction message component 635 as described with reference to FIG. 6.

At 820, the method may include generating a second system message including an instruction for the generative AI model to generate an utterance to be provided to the user and an indication of one or more actions available to the generative AI model. The operations of 820 may be performed in accordance with examples as disclosed herein. In some examples, aspects of the operations of 820 may be performed by a system message component 625 as described with reference to FIG. 6.

At 825, the method may include transmitting, to the generative AI model, a prompt including the first system message, the query-response message pair, the one or more interaction messages, and the second system message. The operations of 825 may be performed in accordance with examples as disclosed herein. In some examples, aspects of the operations of 825 may be performed by a prompt component 640 as described with reference to FIG. 6.

At 830, the method may include receiving, from the generative AI model and based on the prompt, an output of the generative AI model indicating the utterance to be provided to the user by the assistant service. The operations of 830 may be performed in accordance with examples as disclosed herein. In some examples, aspects of the operations of 830 may be performed by an output component 645 as described with reference to FIG. 6.

A method by an apparatus is described. The method may include generating a first system message indicative of a role to be performed by the generative AI model, generating a query-response message pair including a query message including an action invocation and a response message including information responsive to the action invocation, obtaining one or more interaction messages associated with interactions between two or more of a user, an assistant service, and a processing system, generating a second system message including an instruction for the generative AI model to generate an utterance to be provided to the user and an indication of one or more actions available to the generative AI model, transmitting, to the generative AI model, a prompt including the first system message, the query-response message pair, the one or more interaction messages, and the second system message, and receiving, from the generative AI model and based on the prompt, an output of the generative AI model indicating the utterance to be provided to the user by the assistant service.

An apparatus is described. The apparatus may include one or more memories storing processor executable code, and one or more processors coupled with the one or more memories. The one or more processors may individually or collectively be operable to execute the code to cause the apparatus to generate a first system message indicative of a role to be performed by the generative AI model, generate a query-response message pair including a query message including an action invocation and a response message including information responsive to the action invocation, obtain one or more interaction messages associated with interactions between two or more of a user, an assistant service, and a processing system, generate a second system message including an instruction for the generative AI model to generate an utterance to be provided to the user and an indication of one or more actions available to the generative AI model, transmit, to the generative AI model, a prompt including the first system message, the query-response message pair, the one or more interaction messages, and the second system message, and receive, from the generative AI model and based on the prompt, an output of the generative AI model indicating the utterance to be provided to the user by the assistant service.

Another apparatus is described. The apparatus may include means for generating a first system message indicative of a role to be performed by the generative AI model, means for generating a query-response message pair including a query message including an action invocation and a response message including information responsive to the action invocation, means for obtaining one or more interaction messages associated with interactions between two or more of a user, an assistant service, and a processing system, means for generating a second system message including an instruction for the generative AI model to generate an utterance to be provided to the user and an indication of one or more actions available to the generative AI model, means for transmitting, to the generative AI model, a prompt including the first system message, the query-response message pair, the one or more interaction messages, and the second system message, and means for receiving, from the generative AI model and based on the prompt, an output of the generative AI model indicating the utterance to be provided to the user by the assistant service.

A non-transitory computer-readable medium storing code is described. The code may include instructions executable by one or more processors to generate a first system message indicative of a role to be performed by the generative AI model, generate a query-response message pair including a query message including an action invocation and a response message including information responsive to the action invocation, obtain one or more interaction messages associated with interactions between two or more of a user, an assistant service, and a processing system, generate a second system message including an instruction for the generative AI model to generate an utterance to be provided to the user and an indication of one or more actions available to the generative AI model, transmit, to the generative AI model, a prompt including the first system message, the query-response message pair, the one or more interaction messages, and the second system message, and receive, from the generative AI model and based on the prompt, an output of the generative AI model indicating the utterance to be provided to the user by the assistant service.

In some examples of the method, apparatus, and non-transitory computer-readable medium described herein, the one or more actions available to the generative AI model include retrieval of information from the processing system, the second system message includes an instruction for the generative AI model to determine whether information may be to be retrieved from the processing system, and the method further includes receiving a request from the generative AI model to retrieve information from the processing system, and transmitting the retrieved information to the generative AI model, where the utterance to be provided to the generative AI model may be based on the retrieved information, and where the one or more interaction messages include the request from the generative AI model to retrieve the information from the processing system and an indication of the transmission of the retrieved information to the generative AI model.

In some examples of the method, apparatus, and non-transitory computer-readable medium described herein, the one or more actions available to the generative AI model include prompting the user for additional information, the second system message includes an instruction for the generative AI model to determine whether the additional information may be to be requested from the user, and the method further includes receiving a request from the generative AI model to request the additional information from the user, and transmitting the additional information to the generative AI model, where the utterance to be provided to the generative AI model may be based on the additional information, and where the one or more interaction messages include the request from the generative AI model to request the additional information from the user and an indication of the transmission of the additional information to the generative AI model.

In some examples of the method, apparatus, and non-transitory computer-readable medium described herein, the one or more actions available to the generative AI model include prompting the user for confirmation of an action selected from the one or more actions available to the generative AI model, the second system message includes an instruction for the generative AI model to determine whether selected actions may be flagged for user confirmation, and the method further includes receiving a request from the generative AI model to request confirmation of the action from the user, and transmitting the confirmation to the generative AI model, where the utterance to be provided to the generative AI model may be based on the confirmation, and where the one or more interaction messages include the request from the generative AI model to request the confirmation from the user and an indication of the transmission of the confirmation to the generative AI model.

In some examples of the method, apparatus, and non-transitory computer-readable medium described herein, the second system message further includes an indication of one or more response domains selected from a set of response domains including a knowledge domain, a frequency asked questions domain, a security quarantine domain, an escalation domain, or any combination thereof and the one or more response domains may be selected based on an analysis of the first system message, the one or more interaction messages, the second system message, or any combination thereof.

In some examples of the method, apparatus, and non-transitory computer-readable medium described herein, the first system message may be further indicative of a name associated with the generative AI model, an author associated with the generative AI model, a version associated with the generative AI model, a company associated with the generative AI model, a tone associated with the generative AI model, a presence associated with the generative AI model, or any combination thereof.

In some examples of the method, apparatus, and non-transitory computer-readable medium described herein, the query-response message pair may be selected based on a context in which the generative AI model may be to produce the output of the generative AI model.

Some examples of the method, apparatus, and non-transitory computer-readable medium described herein may further include operations, features, means, or instructions for validating the output of the generative AI model to determine whether the utterance indicated in the output of the generative AI model may be responsive to the instruction for the generative AI model to generate the utterance.

In some examples of the method, apparatus, and non-transitory computer-readable medium described herein, interactions between the user and the assistant service may be expressed in plain language, interactions between the generative AI model and the assistant service may be expressed in a structured data format, and interactions between the assistant service and the processing system may be expressed in the structured data format.

The following provides an overview of aspects of the present disclosure:

Aspect 1: A method for prompting a generative artificial intelligence (AI) model comprising: generating a first system message indicative of a role to be performed by the generative AI model; generating a query-response message pair comprising a query message comprising an action invocation and a response message comprising information responsive to the action invocation; obtaining one or more interaction messages associated with interactions between two or more of a user, an assistant service, and a processing system; generating a second system message comprising an instruction for the generative AI model to generate an utterance to be provided to the user and an indication of one or more actions available to the generative AI model; transmitting, to the generative AI model, a prompt comprising the first system message, the query-response message pair, the one or more interaction messages, and the second system message; and receiving, from the generative AI model and based at least in part on the prompt, an output of the generative AI model indicating the utterance to be provided to the user by the assistant service.

Aspect 2: The method of aspect 1, wherein the one or more actions available to the generative AI model comprise retrieval of information from the processing system; the second system message comprises an instruction for the generative AI model to determine whether information is to be retrieved from the processing system; and the method further comprises receiving a request from the generative AI model to retrieve information from the processing system, and transmitting the retrieved information to the generative AI model, wherein the utterance to be provided to the generative AI model is based at least in part on the retrieved information, and wherein the one or more interaction messages comprise the request from the generative AI model to retrieve the information from the processing system and an indication of the transmission of the retrieved information to the generative AI model.

Aspect 3: The method of any of aspects 1 through 2, wherein the one or more actions available to the generative AI model comprise prompting the user for additional information; the second system message comprises an instruction for the generative AI model to determine whether the additional information is to be requested from the user; and the method further comprises receiving a request from the generative AI model to request the additional information from the user, and transmitting the additional information to the generative AI model, wherein the utterance to be provided to the generative AI model is based at least in part on the additional information, and wherein the one or more interaction messages comprise the request from the generative AI model to request the additional information from the user and an indication of the transmission of the additional information to the generative AI model.

Aspect 4: The method of any of aspects 1 through 3, wherein the one or more actions available to the generative AI model comprise prompting the user for confirmation of an action selected from the one or more actions available to the generative AI model; the second system message comprises an instruction for the generative AI model to determine whether selected actions are flagged for user confirmation; and the method further comprises receiving a request from the generative AI model to request confirmation of the action from the user, and transmitting the confirmation to the generative AI model, wherein the utterance to be provided to the generative AI model is based at least in part on the confirmation, and wherein the one or more interaction messages comprise the request from the generative AI model to request the confirmation from the user and an indication of the transmission of the confirmation to the generative AI model.

Aspect 5: The method of any of aspects 1 through 4, wherein the second system message further comprises an indication of one or more response domains selected from a set of response domains comprising a knowledge domain, a frequency asked questions domain, a security quarantine domain, an escalation domain, or any combination thereof; and the one or more response domains are selected based at least in part on an analysis of the first system message, the one or more interaction messages, the second system message, or any combination thereof.

Aspect 6: The method of any of aspects 1 through 5, wherein the first system message is further indicative of a name associated with the generative AI model, an author associated with the generative AI model, a version associated with the generative AI model, a company associated with the generative AI model, a tone associated with the generative AI model, a presence associated with the generative AI model, or any combination thereof.

Aspect 7: The method of any of aspects 1 through 6, wherein the query-response message pair is selected based at least in part on a context in which the generative AI model is to produce the output of the generative AI model.

Aspect 8: The method of any of aspects 1 through 7, further comprising: validating the output of the generative AI model to determine whether the utterance indicated in the output of the generative AI model is responsive to the instruction for the generative AI model to generate the utterance.

Aspect 9: The method of any of aspects 1 through 8, wherein interactions between the user and the assistant service are expressed in plain language, interactions between the generative AI model and the assistant service are expressed in a structured data format, and interactions between the assistant service and the processing system are expressed in the structured data format.

Aspect 10: An apparatus comprising one or more memories storing processor-executable code, and one or more processors coupled with the one or more memories and individually or collectively operable to execute the code to cause the apparatus to perform a method of any of aspects 1 through 9.

Aspect 11: An apparatus comprising at least one means for performing a method of any of aspects 1 through 9.

Aspect 12: A non-transitory computer-readable medium storing code the code comprising instructions executable by one or more processors to perform a method of any of aspects 1 through 9.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for prompting a generative artificial intelligence (AI) model comprising:
generating a first system message indicative of a role to be performed by the generative AI model;
generating a query-response message pair comprising a query message comprising an action invocation and a response message comprising information responsive to the action invocation;
obtaining one or more interaction messages associated with interactions between two or more of a user, an assistant service, and a processing system;
generating a second system message comprising an instruction for the generative AI model to generate an utterance to be provided to the user and an indication of one or more actions available to the generative AI model;
transmitting, to the generative AI model, a prompt comprising the first system message, the query-response message pair, the one or more interaction messages, and the second system message; and
receiving, from the generative AI model and based at least in part on the prompt, an output of the generative AI model indicating the utterance to be provided to the user by the assistant service.

2. The method of claim 1, wherein:
the one or more actions available to the generative AI model comprise retrieval of information from the processing system;
the second system message comprises an instruction for the generative AI model to determine whether information is to be retrieved from the processing system; and
the method further comprises receiving a request from the generative AI model to retrieve information from the processing system, and transmitting the retrieved information to the generative AI model, wherein the utterance to be provided to the generative AI model is based at least in part on the retrieved information, and wherein the one or more interaction messages comprise the request from the generative AI model to retrieve the information from the processing system and an indication of the transmission of the retrieved information to the generative AI model.

3. The method of claim 1, wherein:
the one or more actions available to the generative AI model comprise prompting the user for additional information;
the second system message comprises an instruction for the generative AI model to determine whether the additional information is to be requested from the user; and
the method further comprises receiving a request from the generative AI model to request the additional information from the user, and transmitting the additional information to the generative AI model, wherein the utterance to be provided to the generative AI model is based at least in part on the additional information, and wherein the one or more interaction messages comprise the request from the generative AI model to request the additional information from the user and an indication of the transmission of the additional information to the generative AI model.

4. The method of claim 1, wherein:
the one or more actions available to the generative AI model comprise prompting the user for confirmation of an action selected from the one or more actions available to the generative AI model;
the second system message comprises an instruction for the generative AI model to determine whether selected actions are flagged for user confirmation; and
the method further comprises receiving a request from the generative AI model to request confirmation of the action from the user, and transmitting the confirmation to the generative AI model, wherein the utterance to be provided to the generative AI model is based at least in part on the confirmation, and wherein the one or more interaction messages comprise the request from the generative AI model to request the confirmation from the user and an indication of the transmission of the confirmation to the generative AI model.

5. The method of claim 1, wherein:
the second system message further comprises an indication of one or more response domains selected from a set of response domains comprising a knowledge domain, a frequency asked questions domain, a security quarantine domain, an escalation domain, or any combination thereof; and
the one or more response domains are selected based at least in part on an analysis of the first system message, the one or more interaction messages, the second system message, or any combination thereof.

6. The method of claim 1, wherein the first system message is further indicative of a name associated with the generative AI model, an author associated with the generative AI model, a version associated with the generative AI model, a company associated with the generative AI model, a tone associated with the generative AI model, a presence associated with the generative AI model, or any combination thereof.

7. The method of claim 1, wherein the query-response message pair is selected based at least in part on a context in which the generative AI model is to produce the output of the generative AI model.

8. The method of claim 1, further comprising:
validating the output of the generative AI model to determine whether the utterance indicated in the output of the generative AI model is responsive to the instruction for the generative AI model to generate the utterance.

9. The method of claim 1, wherein interactions between the user and the assistant service are expressed in plain language, interactions between the generative AI model and the assistant service are expressed in a structured data format, and interactions between the assistant service and the processing system are expressed in the structured data format.

10. An apparatus, comprising:
one or more memories storing processor-executable code; and
one or more processors coupled with the one or more memories and individually or collectively operable to execute the code to cause the apparatus to:
generate a first system message indicative of a role to be performed by a generative artificial intelligence (AI) model;
generate a query-response message pair comprising a query message comprising an action invocation and a response message comprising information responsive to the action invocation;
obtain one or more interaction messages associated with interactions between two or more of a user, an assistant service, and a processing system;
generate a second system message comprising an instruction for the generative AI model to generate an utterance to be provided to the user and an indication of one or more actions available to the generative AI model;
transmit, to the generative AI model, a prompt comprising the first system message, the query-response message pair, the one or more interaction messages, and the second system message; and
receive, from the generative AI model and based at least in part on the prompt, an output of the generative AI model indicating the utterance to be provided to the user by the assistant service.

11. The apparatus of claim 10, wherein:
the one or more actions available to the generative AI model comprise retrieval of information from the processing system;
the second system message comprises an instruction for the generative AI model to determine whether information is to be retrieved from the processing system; and
the one or more processors are individually or collectively further operable to execute the code to cause the apparatus to receive a request from the generative AI model to retrieve information from the processing system, and transmit the retrieved information to the generative AI model, wherein the utterance to be provided to the generative AI model is based at least in part on the retrieved information, and wherein the one or more interaction messages comprise the request from the generative AI model to retrieve the information from the processing system and an indication of the transmission of the retrieved information to the generative AI model.

12. The apparatus of claim 10, wherein:
the one or more actions available to the generative AI model comprise prompting the user for additional information;
the second system message comprises an instruction for the generative AI model to determine whether the additional information is to be requested from the user; and
the one or more processors are individually or collectively further operable to execute the code to cause the apparatus to receive a request from the generative AI model to request the additional information from the user, and transmit the additional information to the generative AI model, wherein the utterance to be provided to the generative AI model is based at least in part on the additional information, and wherein the one or more interaction messages comprise the request from the generative AI model to request the additional information from the user and an indication of the transmission of the additional information to the generative AI model.

13. The apparatus of claim 10, wherein:
the one or more actions available to the generative AI model comprise prompting the user for confirmation of an action selected from the one or more actions available to the generative AI model;
the second system message comprises an instruction for the generative AI model to determine whether selected actions are flagged for user confirmation; and
the one or more processors are individually or collectively further operable to execute the code to cause the apparatus to receive a request from the generative AI model to request confirmation of the action from the user, and transmit the confirmation to the generative AI model, wherein the utterance to be provided to the generative AI model is based at least in part on the confirmation, and wherein the one or more interaction messages comprise the request from the generative AI model to request the confirmation from the user and an indication of the transmission of the confirmation to the generative AI model.

14. The apparatus of claim 10, wherein:
the second system message further comprises an indication of one or more response domains selected from a set of response domains comprising a knowledge domain, a frequency asked questions domain, a security quarantine domain, an escalation domain, or any combination thereof; and
the one or more response domains are selected based at least in part on an analysis of the first system message, the one or more interaction messages, the second system message, or any combination thereof.

15. The apparatus of claim 10, wherein the first system message is further indicative of a name associated with the generative AI model, an author associated with the generative AI model, a version associated with the generative AI model, a company associated with the generative AI model, a tone associated with the generative AI model, a presence associated with the generative AI model, or any combination thereof.

16. The apparatus of claim 10, wherein the query-response message pair is selected based at least in part on a context in which the generative AI model is to produce the output of the generative AI model.

17. The apparatus of claim 10, wherein the one or more processors are individually or collectively further operable to execute the code to cause the apparatus to:
validate the output of the generative AI model to determine whether the utterance indicated in the output of the generative AI model is responsive to the instruction for the generative AI model to generate the utterance.

18. The apparatus of claim 10, wherein interactions between the user and the assistant service are expressed in plain language, interactions between the generative AI model and the assistant service are expressed in a structured data format, and interactions between the assistant service and the processing system are expressed in the structured data format.

19. A non-transitory computer-readable medium storing code, the code comprising instructions executable by one or more processors to:
generate a first system message indicative of a role to be performed by a generative artificial intelligence (AI) model;
generate a query-response message pair comprising a query message comprising an action invocation and a response message comprising information responsive to the action invocation;
obtain one or more interaction messages associated with interactions between two or more of a user, an assistant service, and a processing system;
generate a second system message comprising an instruction for the generative AI model to generate an utterance to be provided to the user and an indication of one or more actions available to the generative AI model;
transmit, to the generative AI model, a prompt comprising the first system message, the query-response message pair, the one or more interaction messages, and the second system message; and
receive, from the generative AI model and based at least in part on the prompt, an output of the generative AI model indicating the utterance to be provided to the user by the assistant service.

20. The non-transitory computer-readable medium of claim 19, wherein:
the second system message further comprises an indication of one or more response domains selected from a set of response domains comprising a knowledge domain, a frequency asked questions domain, a security quarantine domain, an escalation domain, or any combination thereof; and
the one or more response domains are selected based at least in part on an analysis of the first system message, the one or more interaction messages, the second system message, or any combination thereof.
